(19) United States
(12) Patent Application Publication
(10) Pub. No.: US 2025/0013711 A1
(43) Pub. Date: Jan. 9, 2025

(54) PARAMETER GENERATION DEVICE, METHOD AND PROGRAM

(71) Applicant: NEC Corporation, Minatoku, Tokyo (JP)

(72) Inventor: Hiroshi CHISHIMA, Tokyo (JP)

(73) Assignee: NEC Corporation, Minato-ku, Tokyo (JP)

(21) Appl. No.: 18/712,310

(22) PCT Filed: Nov. 7, 2022
(86) PCT No.: PCT/JP2022/041341

§ 371 Date: May 22, 2024

(30) Foreign Application Priority Data
Nov. 24, 2021 (JP) 2021-190203

(51) Int. Cl. G06F 17/11

(52) U.S. Cl. CPC G06F 17/11

(57) ABSTRACT

The input means 81 accepts input of a condition to be satisfied by a parameter. The model generation means 82 converts the input condition into a model represented by a Hamiltonian. The annealing process means 83 generates an Ising model from the converted model and inputs the generated Ising model to an annealing machine to perform annealing. The output means 84 converts an annealing result into the parameter and outputs the parameter.

### TECHNICAL FIELD

This invention relates to a parameter generation device, a parameter generation method, and a parameter generation program for generating parameters using an annealing machine, as well as a simulation system and a simulation method for performing trials based on the generated parameters.

### BACKGROUND ART

In a research field of new material exploration, a vast number of combinations of parameters (parameter sets) indicating the type and amount of material, processing temperature, pressure, time, etc., are tried in order to discover a manufacturing method for new materials that will give the desired performance. However, the number of combinations is on an astronomical scale, making it impossible to try all the patterns.

In recent years, annealing machines have been used to attempt such combinations at high speed. An annealing machine is a specialized device for obtaining a ground state of the Hamiltonian of an Ising model.

For example, Patent Literature 1 describes an integer programming device for obtaining a solution to a constrained integer programming problem using an annealing machine. The device described in Patent Literature 1 sets up an annealing machine with a Hamiltonian that includes a first term representing the objective function of the constrained integer programming problem, a second term representing the constraint condition and expressed in a linear expression and a third term expressed in a quadratic expression for multiple spins, and obtains values for the multiple spins obtained.

### CITATION LIST

### Non Patent Literature

PL 1: Japanese Unexamined Patent Application Publication No. 2021-89596

### SUMMARY OF INVENTION

### Technical Problem

On the other hand, from past experience and simulation results, etc., knowledge of combinations of conditions that can be expected to produce good results and combinations of conditions that are inappropriate have been accumulated. In the research field, the process of obtaining results is repeated by defining a new set of parameters within the range that satisfies conditions of these accumulated knowledge, and then conducting prototyping and simulation.

However, when the combination of conditions becomes complex, such as when the conditions are related to each other, it may become difficult to find a parameter set that satisfies all the conditions. Generally, a parameter set that satisfies the conditions is often generated based on the experience and intuition of a skilled person. However, this method has a strong geriatric nature, so it is difficult to efficiently search for parameters without a specific skilled person.

Another possible method is to set parameters randomly and extract parameter sets that satisfy the conditions. However, this method is also inefficient because the more complex the conditions, the lower the probability of generating parameter sets that satisfy the conditions.

The device described in the Patent Literature 1 is designed to solve a combinatorial optimization problem such as the knapsack problem as an integer programming problem, and does not derive a set of parameters to satisfy each condition.

Therefore, it is an object of the present invention to provide a parameter generation device, a parameter generation method and a parameter generation program that can efficiently generate a parameter set that satisfies desired conditions, as well as a simulation system and a simulation method for conducting trials based on the generated parameters.

### Solution to Problem

The parameter generation device according to the present invention includes an input means which accepts input of a condition to be satisfied by a parameter, a model generation means which converts the input condition into a model represented by a Hamiltonian, an annealing process means which generates an Ising model from the converted model and inputs the generated Ising model to an annealing machine to perform annealing, and an output means which converts an annealing result into the parameter and outputs the parameter.

The simulation system according to the present invention includes a simulator which performs trials based on an input parameter, a parameter generation device which generates a parameter to be input to the simulator, and an annealing machine which performs annealing based on an Ising model, wherein the parameter generation device includes an input means which accepts input of a condition to be satisfied by a parameter, a model generation means which converts the input condition into a model represented by a Hamiltonian, an annealing process means which generates an Ising model from the converted model and outputs the generated Ising model to the annealing machine, and an output means which converts an annealing result by the annealing machine into the parameter and outputs the parameter to the simulator, wherein the annealing machine performs annealing based on the Ising model input from the parameter generation device and outputs the annealing result to the parameter generation device, and the simulator performs trials for the input parameter set, and outputs a result of the trials.

The parameter generation method according to the present invention includes: accepting input of a condition to be satisfied by a parameter; converting the input condition into a model represented by a Hamiltonian; generating an Ising model from the converted model; inputting the generated Ising model to an annealing machine to perform annealing; and converting an annealing result into the parameter and outputting the parameter.

The simulation method according to the invention includes: accepting input of a condition to be satisfied by a parameter, by a parameter generation device that generates a parameter to be input to a simulator that performs trials based on input parameter; converting the input condition into a model represented by a Hamiltonian, by the parameter generation device; generating an Ising model from the converted model, by the parameter generation device; outputting the generated Ising model to an annealing machine, by the parameter generation device; performing annealing based on the Ising model input from the parameter generation device, by the annealing machine; outputting an annealing result to the parameter generation device, by the annealing machine; converting an annealing result by the annealing machine into the parameter and outputting the parameter to the simulator, by the parameter generation device; and performing trials for the input parameter set, and outputting a result of the trials, by the simulator.

The parameter generation program according to the present invention for causing a computer to execute: input process for accepting input of a condition to be satisfied by a parameter; model generation process for converting the input condition into a model represented by a Hamiltonian; annealing process for generating an Ising model from the converted model and inputting the generated Ising model to an annealing machine to perform annealing; and outputting process for converting an annealing result into the parameter and outputting the parameter.

### Advantageous Effects of Invention

According to the present invention, a parameter set that satisfies desired conditions can be generated efficiently.

### BRIEF DESCRIPTION OF DRAWINGS

FIG. 1 It depicts a block diagram showing a configuration example of a first example embodiment of the simulation system according to the present invention.

FIG. 2 It depicts an explanatory diagram showing an example of conditions.

FIG. 3 It depicts an explanatory diagram showing an example of a parameter set.

FIG. 4 It depicts an explanatory diagram showing an example of trial results.

FIG. 5 It depicts a flowchart showing an example of an operation of a parameter generation device.

FIG. 6 It depicts a flowchart showing an example of an operation of a simulation system.

FIG. 7 It depicts a block diagram showing a configuration example of a second example embodiment of the simulation system according to the present invention.

FIG. 8 It depicts a block diagram showing an overview of the parameter generation device according to the present invention.

FIG. 9 It depicts a block diagram showing an overview of the simulation system according to the present invention.

### DESCRIPTION OF EMBODIMENTS

Hereinafter, example embodiments of the present invention will be explained with reference to the drawings.

### Example Embodiment 1

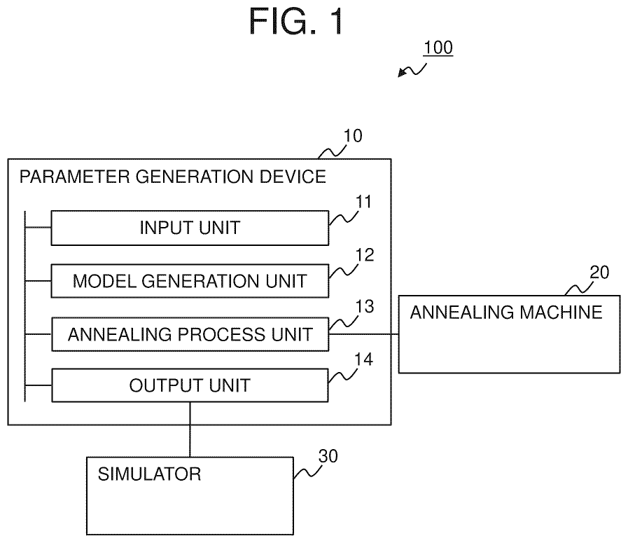

FIG. 1 is a block diagram showing a configuration example of a first example embodiment of the simulation system according to the present invention. The simulation system 100 in this example embodiment includes a parameter generation device 10, an annealing machine 20, and a simulator 30.

The parameter generation device 10 is a device that generates parameters to be input to the simulator 30, and the simulator 30 performs trials based on the generated parameters. The annealing machine 20 is a dedicated device for obtaining the ground state of the Hamiltonian of an Ising model, and performs annealing based on the Ising model generated by the parameter generation device 10.

More specifically, an annealing machine is a device that probabilistically finds the value of a binary variable that minimizes or maximizes the objective function (i.e., Hamiltonian) of an Ising model with a binary variable as an argument. The binary variables may be realized in classical or quantum bits. Note that the form of the annealing machine 20 of this example embodiment is arbitrary. The annealing machine 20 may be constituted by any hardware as long as it probabilistically obtains the value of a binary variable that minimizes or maximizes an objective function with a binary variable as an argument. The annealing machine 20 may be, for example, a non-Neumannian computer in which the objective function is implemented by hardware in the form of an Ising model. The annealing machine 20 may be a quantum annealing machine or a general annealing machine.

The parameters in this example embodiment refer to the values of each attribute to be generated, and more specifically, the values of the attributes to be input to the simulator 30 in order to perform trials. For example, in the case of a trial for a new material manufacturing method, the parameters are, for example, values indicating the amount of each material, the processing temperature and pressure to be set in the manufacturing process, and the processing time. In other cases, for example, when estimating the GDP (Gross Domestic Product) of each country in the case of an increase in the global GDP, the parameters are values indicating, for example, the economic index of each country, the linkage index of each country's GDP, the amount of imports and exports, demographic trends, and so on.

The parameter generation device 10 generates a parameter set that satisfies the desired conditions. It is assumed that, depending on the conditions set, it may not be possible to generate a parameter set that satisfies all constraints. Therefore, in this example embodiment, “a parameter set that satisfies the desired conditions” includes not only a parameter set that satisfies all conditions, but also a parameter set that satisfies the set conditions as much as possible (i.e., a parameter set within a predetermined acceptable range of constraint violation). The acceptable degree and range should be predetermined by the user or other parties.

In other words, in this example embodiment, the “parameter set that satisfies the desired conditions” includes not only the so-called 100-point parameter set that satisfies all conditions, but also the so-called 95-point parameter set in which some constraint violations are allowed. In this example embodiment, since an annealing machine is used to derive the parameters, the values obtained as a result of deriving the ground state of the Hamiltonian can be said to be the parameter set that satisfies the desired conditions.

The parameter generation device 10 includes an input unit 11, a model generation unit 12, an annealing process unit 13, and an output unit 14.

The input unit 11 accepts input of a condition to be satisfied by the parameter (hereafter sometimes simply referred to as the parameter's condition). Specifically, the input unit 11 accepts input of a condition that must be satisfied by the parameter itself and a condition that must be satisfied in relation to other parameters.

The content of the conditions and the manner in which the conditions are expressed are arbitrary. For example, in the case of a trial manufacturing method for a new material, conditions for parameters include conditions for processing the material itself (e.g., upper temperature limit, pressure, processing time, etc.), conditions for exclusive materials, and conditions for distribution of material quantities (e.g., sum of material quantities or designation of individual material quantities). Other conditions for parameters include conditions for selecting a type of material (e.g., specifying one from each of the various material groups, etc.).

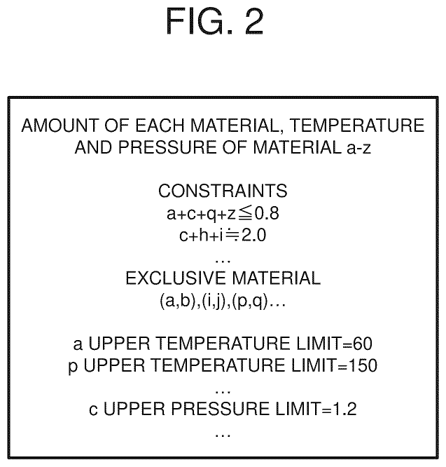

FIG. 2 is an explanatory diagram showing an example of input conditions. The example shown in FIG. 2 indicates that material a through material z exist, and that the amount of each material, the temperature and pressure for each material are included as conditions. Specifically, the example shown in FIG. 2 represents the condition where the total amount of material a, material c, material q, and material z is less than 0.8, and the total amount of material c, material h, and material i is almost 2.0. Other examples shown in FIG. 2 also represent conditions where material a and material b, material i and material j, and material p and material q are not used simultaneously (exclusive), the upper temperature limit for material a is 60, the upper temperature limit for material p is 150, and the upper pressure limit for material c is 1.2.

In the example shown in FIG. 2, the condition of the parameter is given in a mathematical expression, but the condition of the parameter may also be given in a natural language expression.

The input unit 11 may also accept input for the degree of importance given to each condition (hereinafter referred to as the weight of a condition). The weight of a condition may be an absolute value or a relative value. In addition, the input unit 11 may accept input to specify the number of times that the annealing process unit 13, described below, generates parameters (hereinafter referred to as the parameter generation count).

The model generation unit 12 converts the input condition into a model represented by a Hamiltonian. Specifically, the model generation unit 12 converts each input condition into a model represented by a Hamiltonian, and generates a final model from the linear sum of each converted model.

The method of converting the conditions into a model represented by a Hamiltonian is arbitrary. For example, a conversion template may be predetermined for each condition, and the model generation unit 12 may generate a model by determining the content of the input condition, selecting a conversion template, and then applying each element in the condition to the conversion template.

The method of converting to a model is not limited to the method using a conversion template. The model generation unit 12 may, for example, convert conditions into models using a dedicated library that generates models represented by Hamiltonians by inputting the conditions.

The following is a specific example of how the model generation unit 12 converts conditions into a model. In this specific example, the conditions of the parameters for the trial manufacturing method of the new material will be explained as an example. Here, it is assumed that the parameters are the type of material (quantity) and the type of environment (temperature and pressure).

First, the decision variable (quantum bit) xq, which represents the type of material, is defined as follows.
xq [type,quantity]

The “type” represents the type of material and the “quantity” represents the amount in 0.1×10 bits, for example.

Similarly, the decision variable (quantum bit) xe, which represents the type of environment, is defined as follows.
xe [type,volume].

The “type” represents the type of environment, and the “volume” represents the value in 10×10 bits, for example.

The auxiliary variables s1[ ] and s2[ ] are used as appropriate.

The model generation unit 12 models each condition as a Hamiltonian. The constraints illustrated in FIG. 2 will be explained below.

(1) For

$$a + c + q + z \leq 0.8$$

$$H 1 = {( {\sum }_{t ∈ a , c , q , z} {\sum }_{n = 0}^{9} ( xq [ t , n ] * 0.1 ) + {\sum }_{n = 0}^{7} s 1 [ n ] * 0.1 - 0.8 )}^{\hat{}} 2 \qquad ( Equation 1 )$$

The Hamiltonian H1 shown in Equation 1 above is a model that indicates the lowest energy state (ground state) when the value in parentheses (i.e., the sum of the amounts of each material) is within 0.8.

(2) For

$$c + h + i \approx 2.$$

$$H 2 = {( {\sum }_{t ∈ c , h , i} {\sum }_{n = 0}^{9} ( xq [ t , n ] * 0.1 ) - 2. )}^{\hat{}} 2 \qquad ( Equation 2 )$$

The Hamiltonian H2 shown in Equation 2 above is a model that indicates that the closer the value in parentheses (i.e., the sum of the amounts of each material) is to 2.0, the lower the energy state.

(3) Exclusion of a and b

$$H 3 = {\sum }_{n = 0}^{9} ( xq [ a , n ] * {2}^{n} ) * {\sum }_{n = 0}^{9} ( xq [ b , n ] * {2}^{n} ) \qquad ( Equation 3 )$$

The Hamiltonian H3 shown in Equation 3 above is a model that indicates that the value of the Hamiltonian increases when both material a and material b are present (or 0 if at least one is not included).

(4) If a is included, the upper temperature limit 60

$$H 4 = {\sum }_{n = 0}^{9} ( xq [ a , n ] * {2}^{n} ) * {( {\sum }_{n = 0}^{9} ( xq [ T , n ] * 10 ) + {\sum }_{n = 0}^{5} ( s 2 [ n ] * 10 ) - 60 )}^{\hat{}} 2 \qquad ( Equation 4 )$$

### (Equation 4)

The Hamiltonian H4 shown in Equation 4 above is a model that indicates that the energy is lowest when material a is contained and the temperature is within 60.

For example, once these Hamiltonians H1 to H4 are generated, the model generation unit 12 generates a linear sum of each model to make the final model, as illustrated in Equation 5 below. The w1 to w4 are weight constants that indicate the weights of the conditions. The weight constants exemplified in Equation 5 are arbitrary and may be set randomly, for example, or may be the weights of the conditions for which input is received by the input unit 11.

$$H = w 1 * H 1 + w 2 * H 2 + w 3 * H 3 + w 4 * H 4 \qquad ( Equation 5 )$$

The annealing process unit 13 generates an Ising model from the converted model. Specifically, the annealing process unit 13 generates an Ising model from the linear sum of each converted model (e.g., the Hamiltonian shown in Equation 5). Here, both the converted model and the linear sum of each converted model are Hamiltonians. Since the method of generating the Ising model from the Hamiltonian is widely known, a detailed explanation is omitted here.

The annealing process unit 13 then inputs the generated Ising model to the annealing machine 20 to perform annealing, and obtains the execution results. The annealing process unit 13 may have the annealing machine 20 perform annealing only once, or it may have the annealing machine 20 perform annealing for the number of times specified as the parameter generation count. In other words, the annealing process unit 13 may have the annealing machine 20 perform annealing for the same Ising model multiple times.

In the case of general mathematical optimization, the optimal solution is approximately uniquely obtained, whereas the results of execution by an annealing machine usually yield so many different variations that it is difficult to find an identical solution. This can be suitably applied to situations where various variations are obtained while satisfying the conditions, such as when trying out new material manufacturing methods.

The output unit 14 converts an annealing result into a set of parameters and outputs them. This is because the annealing result is different from the representation of the parameters. The output unit 14 may, for example, convert the annealing result into the original parameter set (in other words, values that the simulator 30 can execute) based on the defined decision variables (quantum bit).

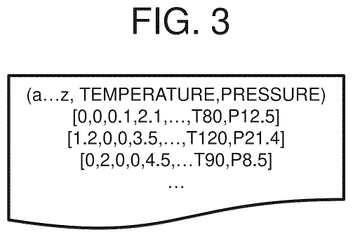

The output unit 14 may output the converted parameter set directly to the simulator 30 or in a file format (e.g., CSV (Comma Separated Value) format). FIG. 3 is an explanatory diagram showing an example of a parameter set output by the output unit 14. The example shown in FIG. 3 shows the result of the output of the parameter set by the output unit 14 in CSV format when the parameter set includes material a to z, temperature, and pressure.

The simulator 30 performs trials for the input parameter set, and outputs a result of the trials (simulated results). For example, if there are multiple trial results (i.e., multiple parameter sets are input), the simulator 30 may display multiple output trial results in a list in association with the parameter set.

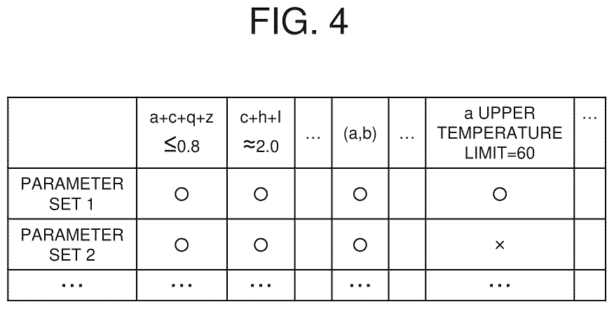

FIG. 4 is an explanatory diagram showing an example of trial results. The trial results illustrated in FIG. 4 show a table with a circle in the column corresponding to the conditions that are satisfied, corresponding to each parameter set. The simulator 30 may, for example, display the parameter sets in order of the number of conditions satisfied, or in order of decreasing energy indicated by the Hamiltonian.

The input unit 11, the model generation unit 12, the annealing process unit 13, and the output unit 14 are realized by a computer processor (e.g., CPU (Central Processing Unit), GPU (Graphics Processing Unit (GPU)) that operates according to a program (parameter generation program).

For example, the program may be stored in the storage unit (not shown) of the parameter generation device 10, and the processor may read the program and operate as the input unit 11, the model generation unit 12, the annealing process unit 13, and the output unit 14 according to the program. The functions of the parameter generation device 10 may be provided in a SaaS (Software as a Service) format.

The input unit 11, the model generation unit 12, the annealing process unit 13, and the output unit 14 may each be realized by dedicated hardware. Also, some or all of the components of each device may be realized by general-purpose or dedicated circuits (circuitry), processors, etc., or a combination thereof. They may be configured by a single chip or by multiple chips connected via a bus. Part or all of each component of each device may be realized by a combination of the above-mentioned circuits, etc. and a program.

When some or all of the components of the parameter generation device 10 are realized by multiple information processing devices, circuits, etc., the multiple information processing devices, circuits, etc. may be centrally located or distributed. For example, the information processing devices and circuits may be realized as a client-server system, a cloud computing system, or the like, each of which is connected via a communication network.

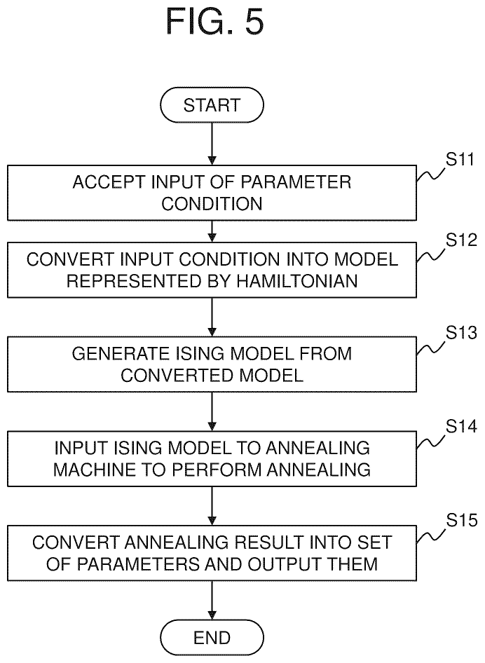

Next, the operation of this example embodiment will be explained. First, the operation of the parameter generation device 10 of this example embodiment is described. FIG. 5 is a flowchart showing an example of an operation of a parameter generation device 10.

The input unit 11 accepts input of parameter conditions (step S11). The model generation unit 12 converts the input condition into a model represented by a Hamiltonian (step S12). The annealing process unit 13 generates an Ising model from the converted model (step S13), and inputs the generated Ising model to an annealing machine to perform annealing (step S14). The output unit 14 then converts an annealing result into a set of parameters and outputs them (step S15).

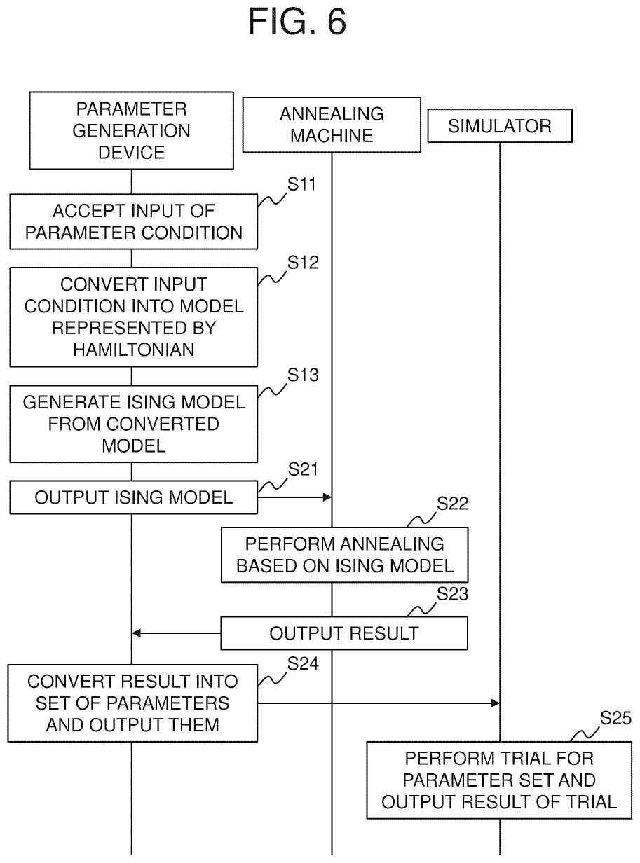

Next, the operation of the simulation system 100 will be described. FIG. 6 is a flowchart showing an example of an operation of a simulation system 100. In this operation example, it is assumed that the output results by the parameter generation device 10 are input to the simulator 30.

The process until the input parameter conditions are converted into a model and the Ising model is generated is the same as the process from step S11 to step S13 illustrated in FIG. 5. The annealing process unit 13 outputs the generated Ising model to the annealing machine (step S21).

The annealing machine 20 performs annealing based on the input Ising model (step S22). The annealing machine 20, for example, obtains multiple spin values by annealing. The annealing machine 20 then outputs an annealing result to the parameter generation device 10 (step S23). The output unit 14 converts the annealing result into a set of parameters and outputs them to the simulator 30 (step S24). The simulator 30 performs trials for the input parameter set and outputs a result of the trials (step S25).

As described above, in this example embodiment, the input unit 11 accepts input of parameter conditions, and the model generation unit 12 converts the input condition into a model represented by a Hamiltonian. The annealing process unit 13 generates an Ising model from the converted model, and inputs the generated Ising model to an annealing machine to perform annealing. The output unit 14 then converts an annealing result into the parameter and outputs the parameter. Thus, a parameter set that satisfies the desired conditions can be generated efficiently.

Next, an example variant of the simulation system of this example embodiment will be described. In the above example embodiment, the case in which the input unit 11 accepts input of so-called constraint conditions as conditions for parameters is described. On the other hand, in this example variant, it is explained a case in which the input unit 11 accepts, as conditions for parameters, inputs of conditions that are more favorable to the results the more they are satisfied, i.e., objective function-like conditions.

Such objective function-like conditions can be obtained, for example, by having AI (Artificial Intelligence) perform machine learning using a large amount of experimental data. The objective function-like condition is, for example, a linear regression model that predicts a performance measure. In this example variant, the simulation system 100 applies this linear regression model to the Hamiltonian and uses it as a condition for desired performance.

The linear regression model is represented by a linear regression equation with the performance indicator (sometimes simply referred to as the indicator) as the objective variable and the parameters described above as explanatory variables. For example, if the predicted value of the i-th indicator is yᵢ, then yᵢ is represented by the linear sum of each parameter. Performance indicators include hardness, flexibility, and heat resistance.

The input unit 11 accepts input of the objective function-like condition described above as input of the condition to be satisfied by the parameters, i.e., accepts input of a linear regression model yᵢ represented by a linear regression equation in which the performance indicator is the objective variable and the parameters are the explanatory variables.

The model generation unit 12 converts the input objective functional condition into a model represented by a Hamiltonian. For example, if the input unit 11 accepts an input of a linear regression model representing N performance indicators, the model generation unit 12 may model from the accepted linear regression model to the Hamiltonian H_{O} illustrated in Equation 6 below.

$$\begin{matrix}[ Math . 5 ] & \\ {H}_{o} = {\sum }_{i}^{n} [ {\{ \frac{( {y}_{i} - {Lmed}_{i} )}{{Lmed}_{i}} \}}^{2} ] \cdot Wi & ( Equation 6 )\end{matrix}$$

In Equation 6, Lmedᵢ is the target median value for the i-th index. For example, if an indicator of hardness is considered desirable in the range of 20 to 25, the target median would be 23. Wᵢ is a predetermined weight based on the importance of each indicator. For example, if heat resistance is more important than hardness, the weight for heat resistance is set greater than the weight for hardness.

The model generation unit 12 then generates a linear sum of each model with the above H_{O} also added, as shown in Equation 5 above, to make the final model. Subsequent processing is the same as in the above example embodiment.

As described above, in this example variant, the input unit 11 accepts input of a linear regression model represented by a linear regression equation in which the performance indicator is an objective variable and the parameter is explanatory variable, and the model generation unit 12 converts the input linear regression model into a model represented by a Hamiltonian. Thus, in addition to the effects of the above example embodiment, a parameter set that satisfies more desired conditions can be generated efficiently.

### Example Embodiment 2

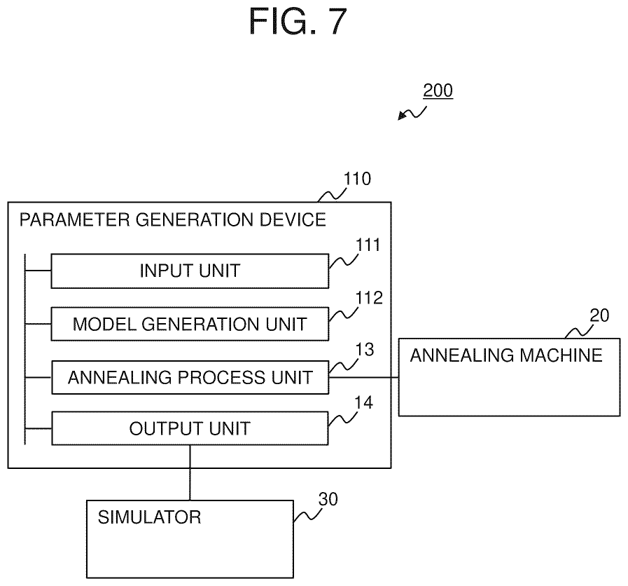

Next, a second example embodiment of the simulation system of the present invention will be described. FIG. 7 is a block diagram showing a configuration example of a second example embodiment of the simulation system according to the present invention. A simulation system 200 of this example embodiment includes a parameter generation device 110, the annealing machine 20, and the simulator 30. The manner of the annealing machine 20 and the simulator 30 is the same as in the first example embodiment.

The parameter generation device 110 includes an input unit 111, a model generation unit 112, an annealing process unit 13, and an output unit 14. In other words, the parameter generation device 110 of this example embodiment differs from the parameter generation device of the first example embodiment in that it includes an input unit 111 and a model generation unit 112 instead of the input unit 11 and the model generation unit 12. Other than that, the configuration is the same as in the first example embodiment.

The input unit 111 accepts input of parameter conditions in the same manner as the input unit 11 of the first example embodiment. Furthermore, the input unit 111 of this example embodiment accepts input of a reference parameter set in addition to the conditions of the parameters. An example of the reference parameter set is a parameter set with good results in the past. By accepting input of the parameter set with good results in the past, it is possible to generate a parameter set that would not significantly alter current operations.

The reference parameter set is not limited to the parameter set with good results in the past. The reference parameter set may be, for example, a parameter set that is currently in operation. By accepting input of the parameter set that is currently in operation, it is possible to generate a parameter set that does not significantly change the current operation.

Similar to the model generation unit 12 of the first example embodiment, the model generation unit 112 converts the input condition into a model represented by a Hamiltonian. Furthermore, the model generation unit 112 generates a modeled Hamiltonian such that the closer the parameter to be generated is to the reference parameter set, the smaller the energy is. The model generation unit 112 then generates the final model from the linear sum of each model.

For example, if the Hamiltonian thus generated is H5 and the weight of H5 is w5, the linear sum of each model is generated as in Equation 7, illustrated below.

$$H = w 1 * H 1 + w 2 * H 2 + w 3 * H 3 + w 4 * H 4 w 5 * H 5 \qquad ( Equation 7 )$$

The input unit 111, the model generation unit 112, the annealing process unit 13, and the output unit 14 are realized by a computer processor that operates according to a program (parameter generation program).

As described above, in this example embodiment, the input unit 111 accepts input of a reference parameter set, and the model generation unit 112 generates a modeled Hamiltonian such that the closer the parameter to be generated is to the reference parameter set, the smaller the energy is. Thus, in addition to the effects of the first example embodiment, the parameter set can be generated so that it is closer to the reference parameter set.

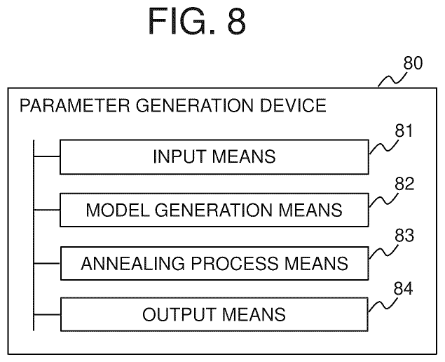

The following is an overview of the invention. FIG. 8 is a block diagram showing an overview of the parameter generation device according to the present invention. A parameter generation device 80 according to the present invention includes an input means 81 (e.g., input unit 11) which accepts input of a condition to be satisfied by a parameter, a model generation means 82 (e.g., model generation unit 12) which converts the input condition into a model represented by a Hamiltonian, an annealing process means 83 (e.g., annealing process unit 13) which generates an Ising model from the converted model and inputs the generated Ising model to an annealing machine to perform annealing, and an output means 84 (e.g., the output unit 14) which converts an annealing result into the parameter and outputs the parameter.

Such a configuration can efficiently generate a parameter set that satisfies desired conditions.

Specifically, the model generation means 82 may convert each input condition into a model represented by a Hamiltonian, respectively, and the annealing process means 83 may generate an Ising model from the linear sum of each converted model.

The input means 81 may accept input of a reference parameter set, and the model generation means may generate a modeled Hamiltonian such that the closer the parameter to be generated is to the reference parameter set, the smaller the energy is. Such a configuration makes it possible to generate a parameter set that is closer to the reference parameter set.

The annealing process means 83 may cause the annealing machine to perform annealing on the same Ising model multiple times. The characteristics of the annealing machine make it possible to obtain various variations of the parameter set.

The input means 81 may, for example, accept input of at least one of the following conditions to be satisfied by the parameter: a condition for processing material itself; a condition for exclusive material; a condition for distribution of material quantities; and a condition for selecting a type of material.

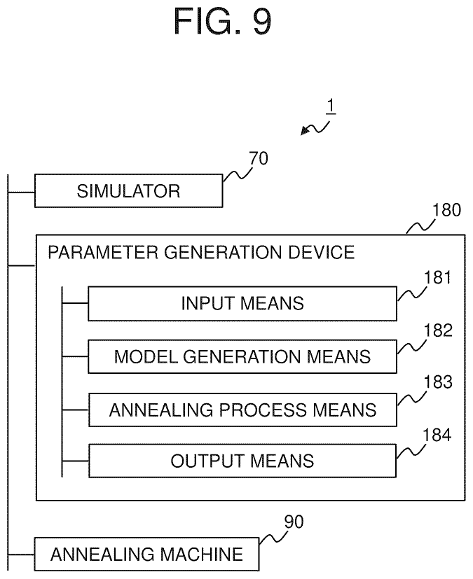

FIG. 9 is a block diagram showing an overview of the simulation system according to the present invention. The simulation system 1 according to the present invention includes a simulator 70 (e.g., the simulator 30) which performs trials based on an input parameter, a parameter generation device 180 (e.g., parameter generation device 10) which generates a parameter to be input to the simulator 30, and an annealing machine 90 (the annealing machine 20) that the annealing machine 90 (e.g., the annealing machine 20) which performs annealing based on an Ising model.

The parameter generation device 180 has an input means 181 (e.g., the input unit 11) which accepts input of a condition to be satisfied by a parameter, a model generation means 182 (e.g., the model generation unit 12) which converts the input condition into a model represented by a Hamiltonian, an annealing process means 183 (e.g., annealing process unit 13) which generates an Ising model from the converted model and outputs the generated Ising model to the annealing machine 90, and an output means 184 (e.g., the output unit 14) which converts an annealing result by the annealing machine 90 into the parameter and outputs the parameter to the simulator 70.

The annealing machine 90 performs annealing based on the Ising model input from the parameter generation device 180 and outputs the annealing result to the parameter generation device 80. The simulator 70 then performs trials for the input parameter set, and outputs a result of the trials.

This configuration allows for efficient generation of parameter sets that satisfy the desired conditions, thus making it possible to conduct trials efficiently.

Although some or all of the above example embodiments may also be described as in the following Supplementary notes, but not limited to the following.

(Supplementary note 1) A parameter generation device comprising:
an input means which accepts input of a condition to be satisfied by a parameter;
a model generation means which converts the input condition into a model represented by a Hamiltonian;
an annealing process means which generates an Ising model from the converted model and inputs the generated Ising model to an annealing machine to perform annealing; and
an output means which converts an annealing result into the parameter and outputs the parameter.

(Supplementary note 2) The parameter generation device according to Supplementary note 1, wherein
the model generation means converts each input condition into a model represented by a Hamiltonian, respectively, and
the annealing process means generates an Ising model from the linear sum of each converted model.

(Supplementary note 3) The parameter generation device according to Supplementary note 1 or 2, wherein
the input means accepts input of a reference parameter set, and
the model generation means generates a modeled Hamiltonian such that the closer the parameter to be generated is to the reference parameter set, the smaller the energy is.

(Supplementary note 4) The parameter generation device according to any one of Supplementary notes 1 to 3, wherein
the annealing process means causes the annealing machine to perform annealing on the same Ising model multiple times.

(Supplementary note 5) The parameter generation device according to any one of Supplementary notes 1 to 4, wherein
the input means accepts input of at least one of the following conditions to be satisfied by the parameter:
a condition for processing material itself;
a condition for exclusive material;
a condition for distribution of material quantities; and
a condition for selecting a type of material.

(Supplementary note 6) The parameter generation device according to any one of Supplementary notes 1 to 5, wherein
the input means accepts input of a linear regression model represented by a linear regression equation in which the performance indicator is an objective variable and the parameter is an explanatory variable; and
the model generation means converts the input linear regression model into a model represented by a Hamiltonian.

(Supplementary note 7) A simulation system comprising:
a simulator which performs trials based on an input parameter;
a parameter generation device which generates a parameter to be input to the simulator; and
an annealing machine which performs annealing based on an Ising model, wherein
the parameter generation device includes:
an input means which accepts input of a condition to be satisfied by a parameter;
a model generation means which converts the input condition into a model represented by a Hamiltonian;
an annealing process means which generates an Ising model from the converted model and outputs the generated Ising model to the annealing machine; and
an output means which converts an annealing result by the annealing machine into the parameter and outputs the parameter to the simulator,
the annealing machine performs annealing based on the Ising model input from the parameter generation device and outputs the annealing result to the parameter generation device, and
the simulator performs trials for the input parameter set, and outputs a result of the trials.

(Supplementary note 8) The simulation system according to Supplementary note 7, wherein
the simulator displays multiple output trial results in a list in association with parameter set.

(Supplementary note 9) A parameter generation method comprising:
accepting input of a condition to be satisfied by a parameter;
converting the input condition into a model represented by a Hamiltonian;
generating an Ising model from the converted model;
inputting the generated Ising model to an annealing machine to perform annealing; and
converting an annealing result into the parameter and outputting the parameter.

(Supplementary note 10) A simulation method comprising:
accepting input of a condition to be satisfied by a parameter, by a parameter generation device that generates a parameter to be input to a simulator that performs trials based on input parameter;
converting the input condition into a model represented by a Hamiltonian, by the parameter generation device;
generating an Ising model from the converted model, by the parameter generation device;
outputting the generated Ising model to an annealing machine, by the parameter generation device;
performing annealing based on the Ising model input from the parameter generation device, by the annealing machine;
outputting an annealing result to the parameter generation device, by the annealing machine;
converting an annealing result by the annealing machine into the parameter and outputting the parameter to the simulator, by the parameter generation device; and
performing trials for the input parameter set, and outputting a result of the trials, by the simulator.

(Supplementary note 11) A parameter generation program for causing a computer to execute:
search process for searching
input process for accepting input of a condition to be satisfied by a parameter;
model generation process for converting the input condition into a model represented by a Hamiltonian;
annealing process for generating an Ising model from the converted model and inputting the generated Ising model to an annealing machine to perform annealing; and
outputting process for converting an annealing result into the parameter and outputting the parameter.

The above description of the present invention is with reference to the embodiments and examples, but the present invention is not limited to the above embodiments and examples. Various changes can be made in the composition and details of the present invention that can be understood by those skilled in the art within the scope of the present invention.

This application claims priority based on Japanese patent application 2021-190203, filed on Nov. 24, 2021, the entire disclosure of which is hereby incorporated.

### REFERENCE SIGNS LIST

10, 110 Parameter generation device
11, 111 Input unit
12, 112 Model generation unit
13 Annealing process unit
14 Output unit
20 Annealing machine
30 Simulator
100, 200 Simulation system

What is claimed is:

1. A parameter generation device comprising:
a memory storing instructions; and
one or more processors configured to execute the instructions to:
accept input of a condition to be satisfied by a parameter;
convert the input condition into a model represented by a Hamiltonian;
generate an Ising model from the converted model and input the generated Ising model to an annealing machine to perform annealing; and
convert an annealing result into the parameter and output the parameter.

2. The parameter generation device according to claim 1, wherein the processor is configured to execute the instructions to:
convert each input condition into a model represented by a Hamiltonian, respectively, and
generate an Ising model from the linear sum of each converted model.

3. The parameter generation device according to claim 1, wherein the processor is configured to execute the instructions to:
accept input of a reference parameter set, and
generate a modeled Hamiltonian such that the closer the parameter to be generated is to the reference parameter set, the smaller the energy is.

4. The parameter generation device according to claim 1, wherein the processor is configured to execute the instructions to
cause the annealing machine to perform annealing on the same Ising model multiple times.

5. The parameter generation device according to claim 1, wherein the processor is configured to execute the instructions to
accept input of at least one of the following conditions to be satisfied by the parameter:
a condition for processing material itself;
a condition for exclusive material;
a condition for distribution of material quantities; and
a condition for selecting a type of material.

6. The parameter generation device according to claim 1, wherein the processor is configured to execute the instructions to:
accept input of a linear regression model represented by a linear regression equation in which the performance indicator is an objective variable and the parameter is an explanatory variable; and
convert the input linear regression model into a model represented by a Hamiltonian.

7. A simulation system comprising:
a simulator which performs trials based on an input parameter;
a parameter generation device which generates a parameter to be input to the simulator; and
an annealing machine which performs annealing based on an Ising model, wherein
the parameter generation device includes:
a memory storing instructions; and
one or more processors configured to execute the instructions to:
accept input of a condition to be satisfied by a parameter;
convert the input condition into a model represented by a Hamiltonian;
generate an Ising model from the converted model and output the generated Ising model to the annealing machine; and
convert an annealing result by the annealing machine into the parameter and output the parameter to the simulator,
the annealing machine performs annealing based on the Ising model input from the parameter generation device and outputs the annealing result to the parameter generation device,
and
the simulator performs trials for the input parameter set, and outputs a result of the trials.

8. The simulation system according to claim 7, wherein
the simulator displays multiple output trial results in a list in association with parameter set.

9. A parameter generation method comprising:
accepting input of a condition to be satisfied by a parameter;
converting the input condition into a model represented by a Hamiltonian;
generating an Ising model from the converted model;
inputting the generated Ising model to an annealing machine to perform annealing; and
converting an annealing result into the parameter and outputting the parameter.

10-11. (canceled)
